(19) United States
(12) Patent Application Publication
(10) Pub. No.: US 2012/0149471 A1
(43) Pub. Date: Jun. 14, 2012

(54) MIXER DEVICE, REPRODUCTION SYSTEM, PLAYER, AND PROGRAM

(75) Inventors: Tetsuro Abe, Inagi (JP); Kazuyoshi Sano, Yokohama (JP); Naohiko Kamiyama, Sopporo (JP); Masaki Furukawa, Saitama (JP)

(73) Assignee: PIONEER CORPORATION, Kanagawa (JP)

(21) Appl. No.: 13/380,696

(22) PCT Filed: Jun. 25, 2009
(86) PCT No.: PCT/JP2009/002917

§ 371 Date: Mar. 5, 2012

(51) Int. Cl. G06F 19/00

(52) U.S. Cl. 463/41

(57) ABSTRACT

A mixer 20 of the invention has a plurality of LAN ports that are connected with a plurality of players 10 and input/output a control signal from/to the players 10, an input detection device 210 that detects that the control signal is input from connected one of the players 10, an ID determination device 220 that determines an ID pre-assigned to the detected one LAN port as an ID of the player 10 connected to the one LAN port, and an ID transmission device 230 that transmits the determined ID to the player 10 through the one LAN port.

### TECHNICAL FIELD

The present invention relates to a mixer which is connected to a plurality of players, obtains and edits reproduction signals reproduced by the players, a reproduction system, a player and a program.

### BACKGROUND ART

Generally, a mixer is connected to a plurality of players, mixes reproduction signals (for example, audio signals) reproduced by each player or makes them continue so as not to pause therebetween for outputting to an output device such as an amplifier or a speaker. This kind of mixer is often used as DJ equipment (equipment for audio performances by a Disc Jockey (DJ)) used for playing music by the DJ mainly in a club or a disco (for example, see Patent Document 1).

[Patent Document 1] JP-A-2003-108132

### DISCLOSURE OF THE INVENTION

### Problems that the Invention is to Solve

When the known mixer is used with a plurality of players, a user (for example, DJ) needs to keep in mind which connection section or channel of the mixer is being connected to which player (connection relationship between the mixer and the players). However, the user needs to check by following cables actually connected or to remember the relationship therebetween for confirming the connection relationship. In the former case, the operation therefor is bothersome because the user needs to check wirings of cables each time. On the other hand, in the latter case, the user may remember the connection relationship wrongly. For example, when the players are changed, cables of other players might be pulled out by mistake.

While, recent DJ equipment may have a share function of music data among the plurality of players. As existing equipment, there are two players each of which is capable of selecting either to read out the music data from a memory inserted therein or to read out the music data from a memory inserted in the other player. In a case that the music data is shared among three or more players, each player needs to be specified for assigning the memory from which the music data is read out. Since the known DJ equipment does not have a function for specifying each player, it is not possible to share the music data among three or more players.

In view of the foregoing problem, it is an advantage of the invention to provide a mixer which lets the user recognize the relationship between the mixer and the players and can specify each player, a reproduction system, a player and a program.

### MEANS FOR SOLVING THE PROBLEMS

According to one aspect of the invention, there is provided a mixer including: a plurality of connection sections that are connected with a plurality of players and input/output a control signal from/to the players; an input detection device that detects that the control signal is input from a player after the player is connected to either one of the plurality of connection sections; an ID determination device that determines an ID pre-assigned to the one connection section detected by the input detection device as an ID of a target player that is the player connected to the one connection section; and an ID transmission device that transmits the determined ID to the target player through the one connection section.

According to another aspect of the invention, there is provided a reproduction system including: a plurality of players; and a mixer connected to the plurality of players, the mixer having: a plurality of connection sections that are connected with the plurality of players and input/output a control signal from/to the players; an input detection device that detects that the control signal is input from a player after the player is connected to either one of the plurality of connection sections; an ID determination device that determines an ID pre-assigned to the one connection section detected by the input detection device as an ID of a target player that is the player connected to the one connection section; and an ID transmission device that transmits the determined ID to the target player through the one connection section; and, the player functioning as the target player having: an ID reception device that receives the ID transmitted from the mixer; an ID setting device that sets the received ID as an ID thereof; and an ID informing device that informs the set ID.

With these configurations, since the mixer sets the ID pre-assigned to the connection section thereof as the ID of the target player which is connected to the connection section thereof, the ID of the connection section can be matched with that of the player. By informing the ID transmitted from the mixer at the player side, the user can recognize which connection section in the mixer is connected to the player. By connecting the audio cable which is the same as the ID of the connection section, a trouble such that connection cables (the cables connecting the connection section and the player) are pulled out by mistake is avoided when the players are replaced or the like. Since each player can be discriminated by the set ID, it is possible to assign a memory in which desired music data has been stored among three or more players, thereby the music data can be shared without any difficulty.

The players may output audio signals or video signals.

Further, the ID informing device may display the ID on a display provided on the player, or may light up or blink indicators corresponding to the ID among a plurality of indicators provided on the player.

As to the mixer described above, it is preferable that the connection section be a LAN port, and the ID determination device determine a port number of the LAN port connected to the player as an ID of the one player.

With this configuration, by using the port number of the LAN port connected to the player as the ID of the player, bothersome process such as ID generation is unnecessary, and the ID of the player can be simply determined. Since the ID of the player and the port number of the LAN port are identical, for example, the user can easily recognize which LAN port is connected with the player by informing the ID at the player side.

As to the mixer above, it is preferable that the mixer further have a plurality of reproduction signal input sections that receive reproduction signals reproduced by the plurality of players, wherein the LAN port function as the connection section and the reproduction signal input section.

With this configuration, transmission of the ID and the reproduction signals between the mixer and the players can be achieved with one interface. The number of connection cables connecting the mixer and the players can be decreased by half, so that bothersome handling for cable connections can be reduced. Since a problem such that the ID of the connection section and the channel number do not match can be avoided, it is possible to be free from a trouble such that connection cables are pulled out by mistake when the players are changed.

According to another aspect of the invention, there is provided a mixer having: a plurality of connection sections that are connected with a plurality of players and input/output a control signal from/to the players; a plurality of reproduction signal input sections that receive a reproduction signal reproduced by the players among the plurality of players; a connecting detection device that detects a player connected to either one of the plurality of connection sections; a reproduction signal request transmission device that transmits a transmission request for the reproduction signals to a target player that is the player connected to the one connection section detected by the connecting detection device through the connection section; a reproduction signal input device that receives the reproduction signal from the target player through either one of the plurality of reproduction signal input sections; an ID determination device that determines a channel number pre-assigned to the one reproduction signal input section input with the reproduction signal as an ID of the target player; and an ID transmission device that transmits the determined ID to the target player through the connection section.

According to another aspect of the invention, there is provided a reproduction system including: a plurality of players; and a mixer connected to the plurality of players, the mixer having: a plurality of connection sections that are connected with the plurality of players and input/output a control signal from/to the players; a plurality of reproduction signal input sections that receive a reproduction signal reproduced by the players among the plurality of players; a connecting detection section that detects a player connected to either one of the plurality of connection sections; a reproduction signal request transmission device that transmits a transmission request for the reproduction signal to a target player that is the player connected to the one connection section detected by the connecting detection device through the connection section; a reproduction signal input device that receives the reproduction signal from the target player through either one of the plurality of reproduction signal input sections; an ID determination device that determines a channel number pre-assigned to the one reproduction signal input section input with the reproduction signal as an ID of the target player; and an ID transmission device that transmits the determined ID to the target player through the connection section, and the player functioning as the target player having: a reproduction signal request reception device that receives the transmission request for the reproduction signal from the mixer; a reproduction signal output device that outputs the reproduction signal to the mixer when the transmission request is received; an ID reception device that receives the ID transmitted from the mixer; an ID setting device that sets the received ID as an ID thereof; and an informing device that informs the set ID.

With these configurations, since the mixer sets the channel number of the reproduction signal input section (audio channel) input with the reproduction signals from the player as the ID of the target player of which connection has been detected, the identical ID can be used for the channel number and the player. By informing the ID transmitted from the mixer at the player side, the user can recognize which player has been connected to which channel of the mixer. With this advantage, it is possible to avoid a trouble such that the audio cables are pulled out by mistake when the players are changed. The connection cables connecting the connection sections with the players do not need to be set with the channel numbers, and thereby can be connected to arbitrary connection sections. Since each player can be discriminated by the set ID, memories storing desired music data in three or more players can be assigned and the music data can be shared without difficulty.

The reproduction signals may be audio signals or video signals.

Further, wired connection or wireless connection may be used for the connections to the “connection sections”.

Still further, the ID informing device may display the ID on a display on the player or may light up or blink indicators corresponding to the ID among indicators provided on the player.

As to the mixer described above, it is preferable that the reproduction signal input device receive inherent information of the target player together with the reproduction signal, and the ID transmission device transmit the ID to the target player specified by the inherent information.

With this configuration, even when the players are connected simultaneously to two or more connection sections among the plurality of connection sections, since each player can be discriminated by the inherent information thereof, the channel number and the ID of the player can be matched steadily.

A MAC address or an IP address can be used for the “inherent information”.

According to another aspect of the invention, there is provided a mixer having: a plurality of connection sections that are connected with a plurality of players and input/output a control signal from/to the players; a plurality of specific information input sections that receive specific information from the plurality of players; a connecting detection device that detects a player connected to either one of the plurality of connection sections; a specific information request transmission device that transmits a transmission request for the specific information to a target player that is the player connected to the one connection section detected by the connecting detection device through the connection section; a specific information input device that receives the specific information from the target player through either one of the plurality of specific information input sections; an ID determination device that determines a channel number pre-assigned to the one specific information input section input with the specific information as an ID of the target player; and an ID transmission device that transmits the determined ID to the target player through the connection section.

According to another aspect of the invention, there is provided a reproduction system including: a plurality of players; and a mixer connected to the plurality of players, the mixer having: a plurality of connection sections that are connected with the plurality of players and input/output a control signal from/to the players; a plurality of specific information input sections that receive specific information from the plurality of players; a connecting detection section that detects a player connected to either one of the plurality of connection sections; a specific information request transmission device that transmits a transmission request for the specific information to a target player that is the a player connected to the one connection section detected by the connecting detection device through the connection section; a specific information input device that receives the specific information from the target player through either one of the plurality of specific information input sections; an ID determination device that determines a channel number pre-assigned to the one specific information input section input with the specific information as an ID of the target player; and an ID transmission device that transmits the determined ID to the target player through the connection section, and the player functioning as the target player having: a specific information request reception device that receives a transmission request for the specific information from the mixer; a specific information output device that outputs the specific information to the mixer when the transmission request is received; an ID reception device that receives the ID transmitted from the mixer; an ID setting device that sets the received ID as an ID thereof; and an informing device that informs the set ID.

With these configurations, since the mixer sets the channel number of the specific information input section receiving the specific information from the player as the ID of the target player of which connection has been detected, it is possible to use an identical ID for the channel number and the ID of the player. By informing the ID transmitted from the mixer at the player side, the user can recognize which channel of the mixer is connected to the player, thereby a trouble in which audio cables are pulled out by mistake is avoided when the players are changed. The connection cables connecting the connecting sections and the players do not need to be set with the channel numbers and can be connected to arbitrary connection sections. Since each player can be discriminated by the set ID, it is possible to assign a memory in which desired music data has been stored among three or more players, thereby the music data can be shared without any difficulty.

The players may output audio signals or video signals.

Further, wired connection or wireless connection may be used for the connections to the “connection sections”.

Also, the ID informing device may display the ID on a display on the player or may light up or blink indicators corresponding to the ID among indicators provided on the player.

Still further, user data bits or channel status bits can be used as the “specific information”.

As to the mixer described above, it is preferable that the specific information request transmission device transmit a transmission request for the specific information corresponding to the one connection section detected by the connecting detection device, and the ID transmission device transmit the ID through a connection section corresponding to the specific information input from the specific information input device.

With this configuration, even when the players are connected simultaneously to two or more connection sections among the plurality of connection sections, since the connection section to which the ID is transmitted can be discriminated based on the input specific information, the channel number can be steadily matched with the ID of the player.

As to the reproduction system described above, it is preferable that the player further have, when the player is connected to one or more other players in network, a storage device that stores a plurality of IDs for specifying itself; an ID provisional determination device that provisionally determines one arbitrary ID as an ID thereof among the plurality of stored IDs; and an ID discrimination device that discriminates whether the provisionally determined arbitrary ID is assigned to one of the other players, and wherein the ID setting device set the arbitrary ID as an ID thereof when no other player assigned with the arbitrary ID exists based on the discrimination result by the ID discrimination device.

With this configuration, the player can set the ID for specifying itself without the mixer. In short, even when the mixer does not have a function for setting the ID to each player, the ID can be set for specifying each player.

As to the reproduction system described above, it is preferable that the ID informing device inform an ID list of the other players connected to the player in addition to the set ID of the player itself.

With this configuration, since the ID list of other connected players is informed, the user can assign one of the players based on the ID list, thereby the desired music data can be easily selected.

It is preferable that the player of the invention can be applied to the reproduction system described above.

It is preferable that a program of the invention cause a computer to function as each device of the mixer or the player in the reproduction system described above.

By using the player and the program above, it is possible to provide the reproduction system having two advantages by which the user can recognize a connection relationship between the mixer and the player and can discriminate each player.

### BRIEF DESCRIPTION OF THE DRAWINGS

FIG. 1 is a simple structure diagram of a reproduction system according to the first embodiment.

FIG. 2 is a functional block diagram of the reproduction system according to the first embodiment.

FIG. 3 is a flowchart explaining an ID setting process of the reproduction system according to the first embodiment.

FIG. 4 is a diagram illustrating a display example of a display provided on a player.

FIG. 5 is a simple structure diagram illustrating a modification of the reproduction system according to the first embodiment.

FIG. 6 is a functional block diagram of the reproduction system according to the second embodiment.

FIG. 7 is a flowchart explaining the ID setting process of the reproduction system according to the second embodiment.

FIG. 8 is a functional block diagram of the reproduction system according to the third embodiment.

FIG. 9 is a simple structure diagram of the reproduction system according to the fourth embodiment.

FIG. 10 is a functional block diagram of the player according to the fourth embodiment.

FIG. 11 is a flowchart explaining the ID setting process of the player according to the fourth embodiment.

### DESCRIPTION OF EXEMPLARY EMBODIMENTS

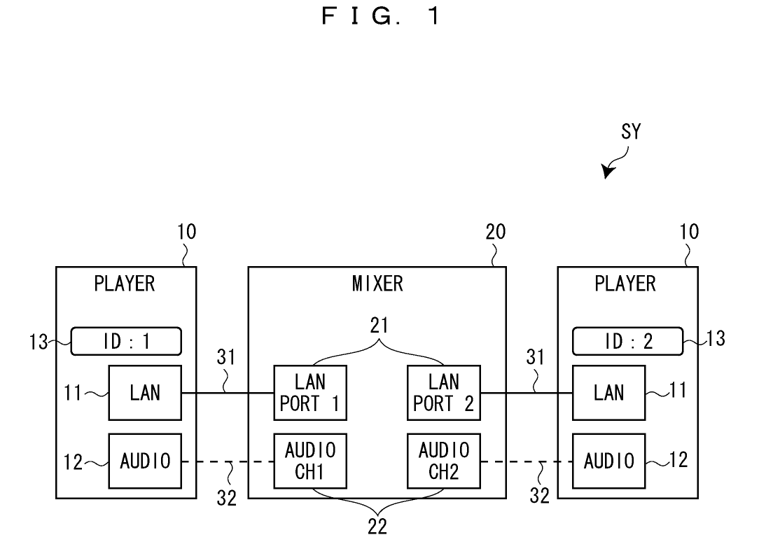

A mixer, a reproduction system, a player and a program according to one embodiment of the invention will be explained in detail referring to accompanying drawings. FIG. 1 is a simple structure diagram of a reproduction system SY according to the first embodiment. As illustrated in FIG. 1, the reproduction system SY has a plurality of players 10 (two players in FIG. 1) and a mixer 20 which controls to output reproduction signals obtained from each player 10. The reproduction system SY of the embodiment is an audio system and the players 10 output audio signals.

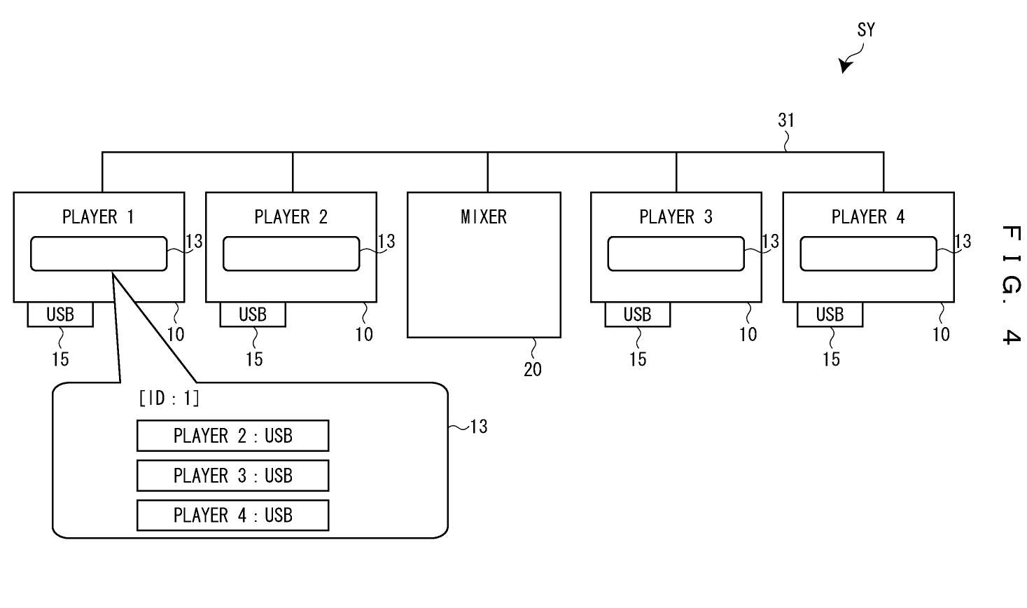

Various devices such as a USB memory 15 (see FIG. 4), a CD and an SD memory card can be inserted in player 10 and the player 10 reads out music to reproduce from each device. The player 10 further has manipulation members (not shown) such as a jog dials etc. and performs a reproduction process such as adjustment of a reproduction state and effect addition.

As illustrated in FIG. 1, each player 10 further has a LAN terminal 11 for connecting in LAN to the mixer 20, an audio output terminal 12 for outputting audio signals generated by reproducing the music to the mixer 20, and a display 13 for displaying various pieces of information.

Each player 10 obtains control signals from the mixer 20 via the LAN terminal 11. More specifically, the control signals are for fader start play, back cue, and the like. Further, automatic alternative reproduction (relay play) can be performed by connecting the LAN terminal 11 of the player 10 with the LAN terminal 11 of the other player 10. In the embodiment, the LAN terminal is further used to obtain an ID from the mixer 20. The obtained ID is set to specify each player 10 when the automatic alternative reproduction or sharing music data is performed. Still further, the ID is displayed on the display 13 so that a user can recognize connection relationship between the mixer 20 and each player 10.

While, the mixer 20 has manipulation members such as a channel fader and a cross fader (not shown) and performs a mixing process and the like of the input reproduction signals from each player 10. Further, the mixer 20 is connected to an output device (not shown) having an amplifier and a speaker via audio cables (not shown) and outputs the audio signals after the mixing process thereto.

Further, as illustrated in FIG. 1, the mixer 20 has a plurality of LAN ports 21 (connection sections) for connecting in LAN with each player 10 and a plurality of audio ports 22 (reproduction signal input sections) (hereinafter, referred as “audio channels”) for obtaining the audio signals from each player 10. The LAN ports 21 of the mixer 20 are connected with the LAN terminal 11 of each player 10 via LAN cables 31. Ethernet (trade mark) cables may be used as the LAN cables 31. Further, the audio channels 22 of the mixer 20 are connected with the audio output terminal 12 of each player via an audio cable 32. HDMI cables or an RCA cables may be used as the audio cables 32.

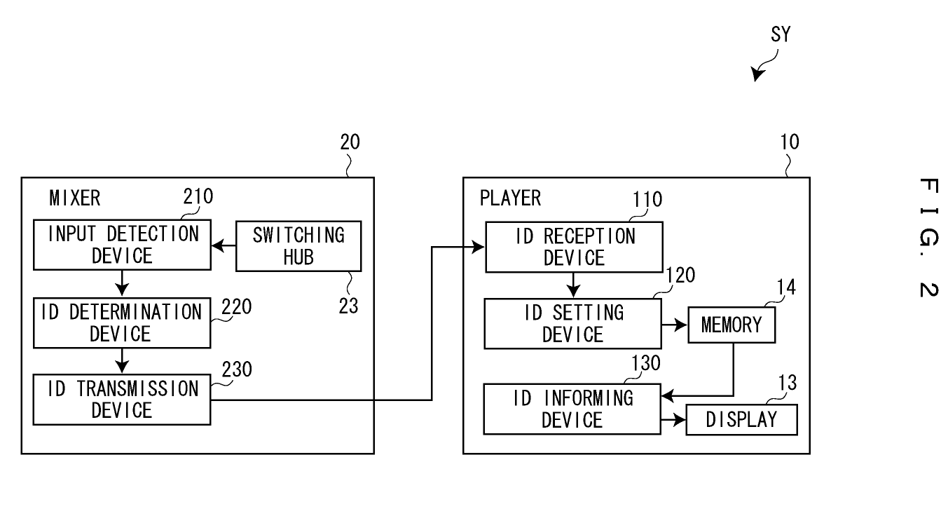

Referring to FIG. 2, a functional structure of the reproduction system SY will be explained. The mixer 20 has an input detection device 210, an ID determination device 220 and an ID transmission device 230 as main functional structures.

The input detection device 210 detects that a frame (control signals) is input from a player 10 after the player 10 has been connected to either one LAN port among the plurality of LAN ports 21 mounted in the mixer 20. The detection by the input detection device 210 is performed with a function of a switching hub 23 built in the mixer 20. Since the switching hub 23 manages connected equipment per port, after the player 10 has been connected to the mixer 20, it is possible to discriminate from which port of the switching hub 23 the frame has been through by receiving the frame from the player 10. In other words, it is possible to specify the LAN port 21 to which the player 10 has been connected.

The ID determination device 220 determines an ID pre-assigned to the LAN port 21 detected by the input detection device 210 as an ID of a target player which is the player 10 connected to the LAN port 21. In other words, an input port number receiving the frame is determined as the ID of the player 10 as it is.

The ID transmission device 230 transmits the ID determined by the ID determination device 220 to the target player via the LAN port 21 detected by the input detection device 210.

A functional structure of the player 10 (target player) will be explained hereinbelow. The player 10 has an ID reception device 110, an ID setting device 120 and an ID informing device 130 as main functional structures.

The ID reception device 110 receives the ID transmitted from the ID transmission device 230 of the mixer 20 via the LAN terminal 11.

The ID setting device 120 sets the ID received by the ID reception device 110 as an ID thereof. More specifically, the received ID is stored in a memory 14 provided in the player 10.

The ID informing device 130 informs the ID set by the ID setting device 120 by displaying on the display 13. The informing continues (continues to be displayed), after the ID setting, until a power of the player 10 is turned off. The informing by the ID informing device 130 may be performed by providing a plurality of indicators on the player 10 and lighting up or blinking the indicators corresponding to the ID among the plurality of indicators. Further, the informing may be performed with sound.

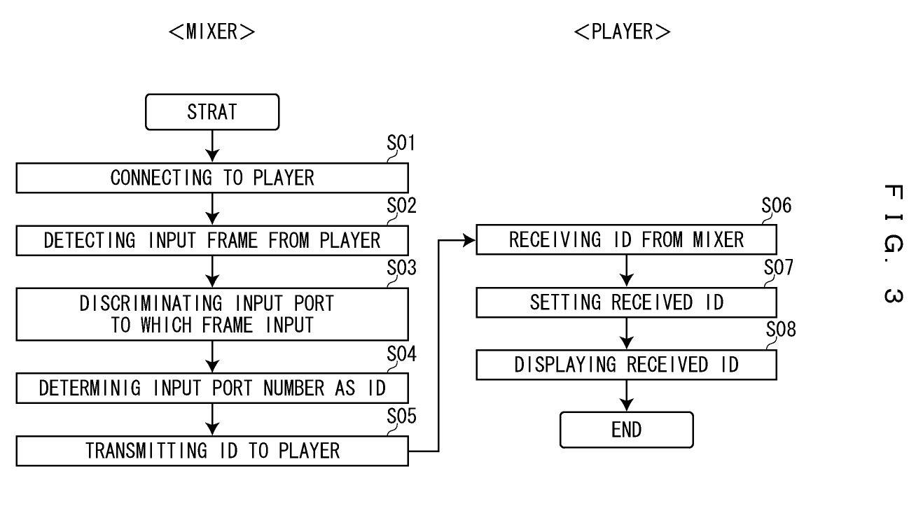

Referring to a flowchart of FIG. 3, an ID setting process of the reproduction system SY according to the first embodiment will be explained. The mixer 20 is connected to the player 10 (S01), detects that the frame is input from the player 10 (S02), then, discriminates the input port (LAN port 21) to which the frame has been input (S03) with the function of the switching hub 23. Based on the discrimination result, the mixer 20 determines an input port number as the ID (S04) and transmits the determined ID to the target player connected to the input port input with the frame (S05).

On the other hand, the player 10 receives the ID from the mixer 20 (S06), sets the received ID as the ID thereof (S07), and displays the ID on the display 13 (S08).

Thus, the reproduction system SY of the embodiment can set the ID with which each player 10 can be easily specified only by connecting the player 10 with the mixer 20. When the plurality of players 10 are connected to the mixer 20, the ID of each player 10 is sequentially set in the order that the frame thereof is input (each of the detection in S02).

Referring to FIG. 4, a display example on the display 13 will be explained. The mixer 20 is exemplified which is connected with three players 10 in LAN via LAN cables 31 and a USB memory 15 is inserted in each player 10. Each player 10 can share music data.

In this case, for example, an ID set for “player 1” (in FIG. 4, “ID: 1”) by the ID informing device 130 above is displayed on the display 13 of the “player 1”.

Further, a list of the devices (USB memories 15) inserted into other players 10 other than the “player 1” is displayed with the ID of each player 10. The ID of each player 10 is information obtained from the mixer 20. In other words, the mixer 20 transmits, after setting the ID for each player 10, the set ID and information about the device inserted therein to each player 10. Alternatively, the player 10 may inquiry to the mixer 20 and the mixer 20 may provide the ID and the information about the device in response to the inquiry. Further, each player 10 may inform the set ID therefor and the information about the device inserted therein to the other players 10.

With this structure, for example, in a case the music data in the USB memory 15 inserted in a “player 2” needs to be read out by the “player 1”, a content of the target device can be refereed by selecting the target device (in FIG. 4, “player 2: USB”) from the list of the devices.

When the target device is selected by the user's operation, the player 10 displays music information (meta data) of the music stored in the device on the display 13. Therefore, the user enables the “player 1” to obtain desired music data by selecting either one piece of music information from the list of the music information.

In a case that a plurality types of devices are inserted in the player 10, selection candidates per device are displayed in the device list (for example, “player 2: USB”, “player 2: SD”, and the like). Further, the device list may be always displayed while the player 10 is activated, or may be temporarily displayed when the user performs a predetermined operation.

As explained above, according to the first embodiment of the invention, since the mixer 20 sets the pre-assigned number to each LAN port 21 as the ID of the target player connected to the LAN port 21, the ID of the LAN port 21 can be set to be identical to that of the player 10. Further, at the player 10 side, since the ID transmitted from the mixer 20 is informed, the user can recognize which LAN port 21 of the mixer 20 is connected to the player 10. Therefore, by connecting the audio cable 32 to a same channel as the ID of the LAN port 21, it is possible to avoid a trouble such that LAN cables 31 are pulled out by mistake when the players 10 are changed.

Further, since each player 10 can be discriminated by the ID displayed on the display 13 of each player 10, it is easily possible to select the desired music data even when the music data is shared among three or more players 10.

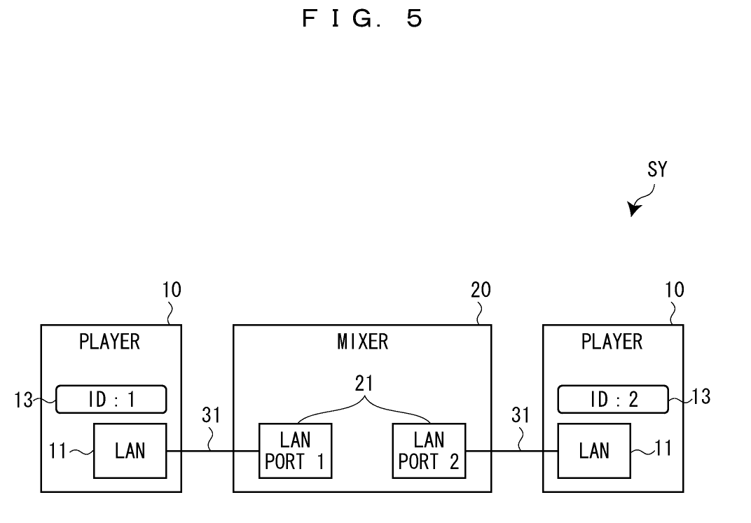

The reproduction system SY exemplified in the above embodiment has the mixer 20 and the players 10 each of which is connected to the mixer 20 via the LAN cable 31 and the audio cable 32, but the LAN cable 31 and the audio cable 32 may be integrated. In this case, the audio output terminals 12 of the players 10 and the audio cables 32 are unnecessary, and the audio signals are transmitted/received via the LAN cables 31 as illustrated in FIG. 5. By transmitting the set IDs together with the audio signals to the mixer 20 from the players 10 after the IDs have been set, the mixer 20 can process the audio signals per audio channel. In a case that the mixer 20 has a structure in which it memorizes to relate the LAN ports 21 to the audio channels 22, the players 10 do not have to transmit the IDs with the audio signals.

Thus, according to the structure illustrated in FIG. 5, since the transmission of ID and the audio signals between the mixer 20 and the player 10 can be achieved with a single interface, cost can be reduced than the case in which the operations above are performed with separate interfaces. Also, since the number of connection cables connecting the mixer 20 with the players 10 is decreased by half, time and effort for cable connection can be reduced. Further, since the ID is determined based on the LAN port 21 and is used as the audio channel 22 as it is, the ID of the LAN port 21 and the channel number always coincide, by which a trouble such that the LAN cables 31 are pulled out by mistake can be avoided when the players 10 are changed.

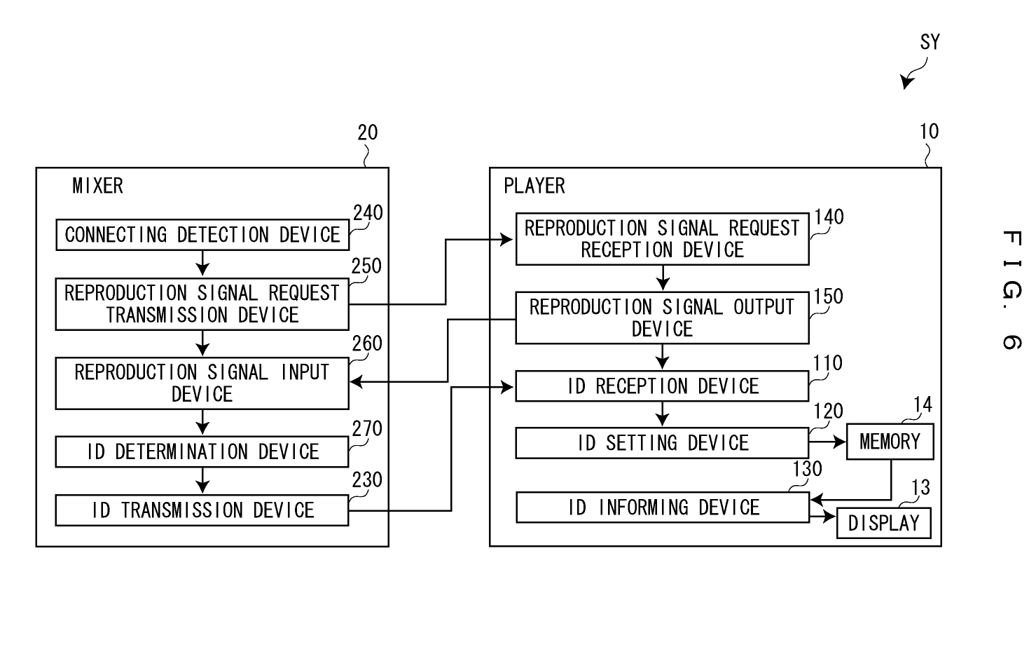

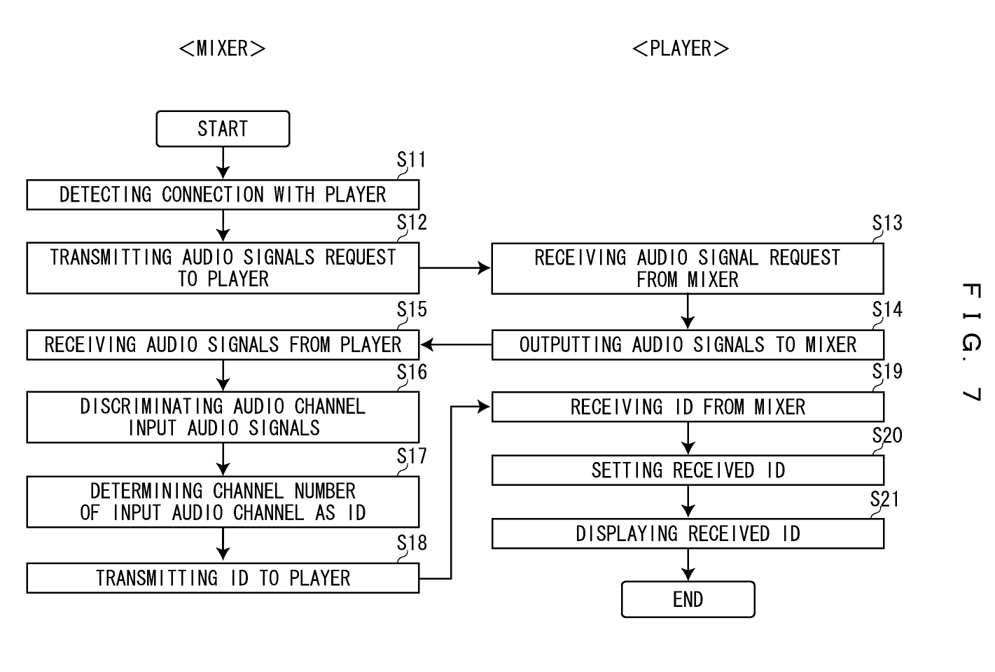

Referring to FIGS. 6 and 7, the second embodiment of the invention will be explained. In the first embodiment above, the mixer 20 determines the ID based on the LAN port 21, but this embodiment differs in that the ID is determined based on the audio channel 22. Hereinafter, aspects different from the first embodiment will be mainly explained. In this embodiment, same references are assigned to the same structure elements of the first embodiment and the details therefor are omitted. Further, modifications applied to the same structure elements with those of the first embodiment can be also applied to the second embodiment.

FIG. 6 is a functional block diagram of the reproduction system SY according to the second embodiment. The mixer 20 of the second embodiment has a connecting detection device 240, a reproduction signal request transmission device 250, a reproduction signal input device 260, an ID determination device 270 and an ID transmission device 230 as main structure elements.

The connecting detection device 240 detects which LAN port 21 among the plurality of LAN ports 21 is connected to the player 10.

The reproduction signal request transmission device 250 transmits a transmission request for certain audio signals to the target player which is the player 10 connected to the above LAN port 21 of which connection has been detected via the LAN port 21, triggered by the detection by the connecting detection device 240. The certain audio signals are, for example, predetermined signals such as “audio signals of XX KHz for continuing XX seconds”. The certain audio signals are pre-stored in the player 10.

The reproduction signal input device 260 receives the certain audio signals from the above target player via either one audio channel 22 among the plurality of audio channels 22 provided in the mixer 20.

The ID determination device 270 determines the channel number pre-assigned to the audio channel 22 input with the certain audio signals as the ID of the target player. The ID transmission device 230 transmits the ID determined by the ID determination device 270 to the target player as the first embodiment.

The player 10 of the second embodiment has a reproduction signal request reception device 140, a reproduction signal output device 150, an ID reception device 110, an ID setting device 120 and an ID informing device 130 as main structure elements.

The reproduction signal request reception device 140 receives the transmission request for the certain audio signals from the mixer 20 via the LAN terminal 11.

When the reproduction signal request reception device 140 receives the transmission request for the certain audio signals, the reproduction signal output device 150 outputs the pre-stored certain audio signals to the mixer 20 via the audio output terminal 12. The ID reception device 110, the ID setting device 120 and the ID informing device 130 function as those in the first embodiment.

FIG. 7 is a flowchart explaining the ID setting process of the reproduction system SY according to the second embodiment. The mixer 20, first of all, detects the connection with the player 10 (S11), then transmits the audio signal request to the target player which is the player 10 via the LAN port 21 (S12). The player 10 (target player) receives the audio signal request from the mixer 20 (S13), and outputs the certain audio signals to the mixer 20 (S14).

When the mixer 20 receives the certain audio signals from the player 10 (S15), the audio channel 22 to which the audio signals are input is discriminated (S16). Further, the mixer 20 determines the channel number of the input audio channel 22 as the ID (S17), and transmits the ID via the LAN port 21 of which connection is detected (S18). When the player 10 receives the ID from the mixer 20 (S19), it sets the received ID as the ID thereof (S20) and displays the ID on the display 13 (S21).

In the case that the plurality of players 10 are connected to the mixer 20, the ID of each player 10 is set sequentially in the order that the connections of the players 10 are detected (per detection in S11).

As explained above, according to the second embodiment of the invention, since the mixer 20 sets the channel number of the audio channel 22 in which the audio signals are input from the player 10 as the ID of the target player of which connection is detected, it is possible to make the ID of the channel number the same as the ID of the player 10. Further, at the player 10 side, since the ID transmitted from the mixer 20 is informed, the user can recognize which channel of the mixer 20 is connected to the player 10. Therefore, it is possible to avoid a trouble such that audio cables 32 are pulled out by mistake when the players 10 are changed. Further, the LAN port 21 connected to the player 10 via the LAN cable 31 does not need to match with the channel number and an arbitrary LAN port 21 can be connected.

In the embodiment above, the ID of each player 10 is set sequentially in the order that the connections of the player 10 are detected, but there may be a case that the ID can not be set correctly when the players 10 are connected simultaneously. In such a case, it is preferable that the reproduction signal output device 150 of the player 10 output the audio signals including a MAC address (inherent information) by digital watermark. In this case, the audio signals including the MAC address are input in the reproduction signal input device 260 of the mixer 20, and the ID corresponding to the input channel is input to equipment of the MAC address included in the audio signals by the ID transmission device 230. According to the structure, even when the players 10 are connected simultaneously, it is possible to steadily match the channel number of the audio channel 22 with the ID of the player 10.

As the inherent information included in (added to) the audio signals by digital watermark, an IP address and the like can be used in addition to the MAC address. When the HDMI is employed (when HDMI cables are used as the audio cables 32) as an input/output interface standard, the reproduction signal output device 150 can output the inherent information through a control signal line.

The transmission request for the audio signals corresponding to the LAN port 21 detected by the connecting detection device 240 may be transmitted for the case in which the players 10 are connected simultaneously. For example, the value of XX (length and/or frequency of the audio signals) in “audio signals of XX KHz for continuing XX seconds” of the certain audio signals may be changed per LAN port 21. In short, when the mixer 20 detects the connection with a “LAN port 1”, the audio signals of 19 kHz may be requested, and, when the mixer 20 detects the connection with a “LAN port 2”, the audio signals of 20 kHz may be requested.

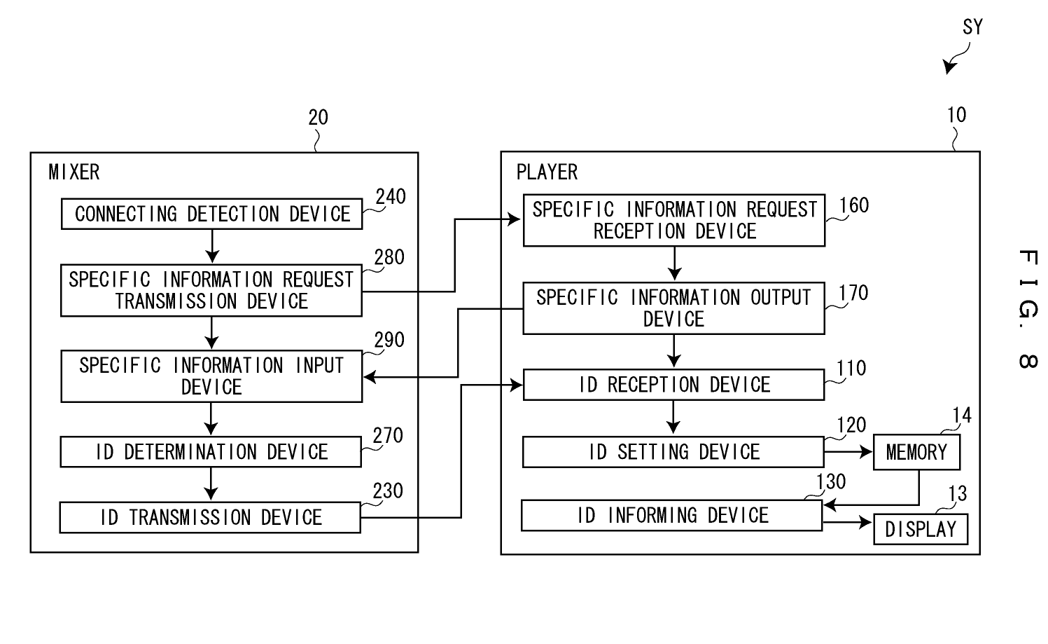

Referring to FIG. 8, the third embodiment of the invention will be described. In the second embodiment above, the ID is determined based on the input channel of the audio signals, but the third embodiment differs in that the ID is determined based on the input channel of specific information. The differences from the second embodiment will be mainly explained hereinafter. The same references are assigned to structure elements of the third embodiment which are the same as those of the first and/or second embodiment(s) and the details therefor are omitted. Modifications applied to the same structure elements in the first and/or second embodiment(s) are applied to the third embodiment.

FIG. 8 is a functional block diagram of the reproduction system SY according to the third embodiment. The mixer 20 of the third embodiment has a structure in which the reproduction signal request transmission device 250 and the reproduction signal input device 260 in the mixer 20 of the second embodiment are changed to a specific information request transmission device 280 and a specific information input device 290. With this change, the reproduction signal request reception device 140 and the reproduction signal output device 150 of the player 10 are changed to a specific information request reception device 160 and a specific information output device 170.

The specific information request transmission device 280 of the mixer 20 transmits a transmission request for specific information to the target player which is the player 10 connected to the LAN port 21 of which connection has been detected via the LAN port 21, triggered by the detection by the connecting detection device 240. As the specific information, “user data bits” indicating a reproduction position or the like of the device, “channel status bits” indicating copyright information or the like may be used.

On the other hand, the specific information request reception device 160 of the player 10 receives the transmission request for the specific information from the mixer 20 via the LAN terminal 11. Further, the specific information output device 170 outputs the specific information to the mixer 20 via the audio output terminal 12 when the transmission request for the specific information is received by the specific information request reception device 160.

The specific information input device 290 of the mixer 20 receives the specific information from the above target player via one of the plurality of audio channels 22 provided in the mixer 20.

Also, the ID determination device 270 of the third embodiment determines, as the second embodiment, the channel number pre-assigned to the audio channel 22 (specific information input section) to which the specific information is input as the ID of the target player, and the ID transmission device 230 transmits the ID determined by the ID determination device 270 to the target player.

Since the ID setting process of the reproduction system SY according to the third embodiment can be realized by replacing the “audio signals” in the ID setting process of the reproduction system SY according to the second embodiment (see FIG. 7) to the “specific information”, a flowchart and the explanation therefor is omitted.

As described above, according to the third embodiment of the invention, the mixer 20 sets the channel number of the audio channel 22 which receives the specific information from the player 10 as the ID of the target player of which the connection has been detected. Therefore, the third embodiment can have effects and advantages as those of the second embodiment.

In the third embodiment, the ID of each player is also set sequentially in the order that the connections of the players 10 have been detected, but when the players 10 are connected simultaneously, there arises the problem in which the ID can not be set properly. In such a case, the specific information request transmission device 280 may transmit the transmission request for the specific information corresponding to the LAN port 21 detected by the connecting detection device 240. For example, when the channel status bits are used as the specific information and the mixer 20 detects the connection with the “LAN port 1”, 33rd bit in the channel status may be requested to turn on, and when the connection with the “LAN port 2” is detected, 34th bit in the channel status may be requested to turn on.

In this case, the specific information output device 170 of the player 10 outputs the channel status corresponding to the request from the mixer 20. Also, the ID transmission device 230 of the mixer 20 transmits the ID via the LAN port 21 corresponding to the cannel status bits input by the specific information input device 290 (for example, “LAN port 1” when the 33rd bit is on). According to the structure, even when the players 10 are connected simultaneously, it is possible to discriminate the LAN port 21 by which the ID should be transmitted based on the input specific information. Therefore, the channel number of the audio channel 22 can be steadily matched with the ID of the player 10.

When the user data bits are used as the specific information, it is possible to discriminate the connected audio channel 22 based on a position where the user data bits are turned on/off. Further, in the third embodiment, S/PDIF can be employed as the input/output interface standard.

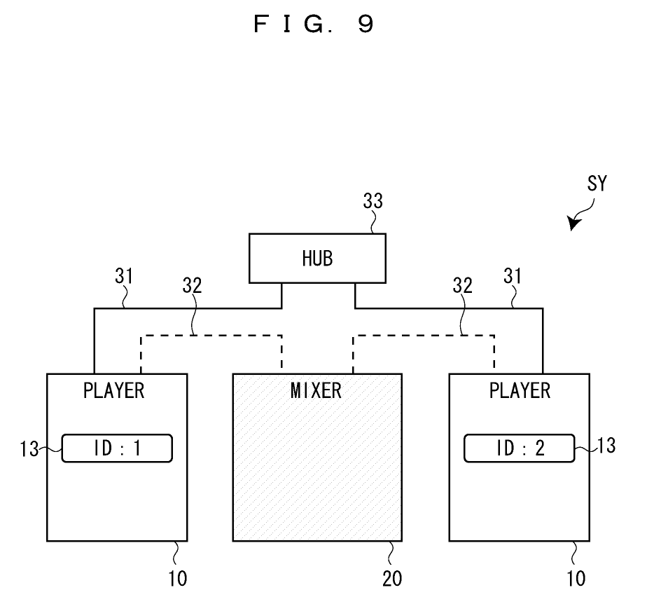

Referring to FIGS. 9 to 11, the fourth embodiment of the invention will be explained. In the above first to third embodiments, the ID is set mainly by the mixer 20, but the fourth embodiment differs in that the ID is set by the player 10 itself. The differences from each embodiment above will be mainly explained hereinafter. In the fourth embodiment, the same references are assigned to structure elements which are the same as those in each embodiment above, and details therefor are omitted. Modifications applied to the same structure elements in each embodiment above are applied to the fourth embodiment.

FIG. 9 is a simple structure diagram of the reproduction system SY according to the fourth embodiment. As illustrated in FIG. 9, in the reproduction system SY of the fourth embodiment, the players 10 are connected to each other through the LAN cables 31 and a hub 33. Each player 10 is connected to the mixer 20 via the audio cable 32 one to one. In the fourth embodiment, as mentioned above, since the ID is set by the player 10 itself, the mixer 20 does not need to have the ID setting function therein. In short, an existing mixer 20 can be employed.

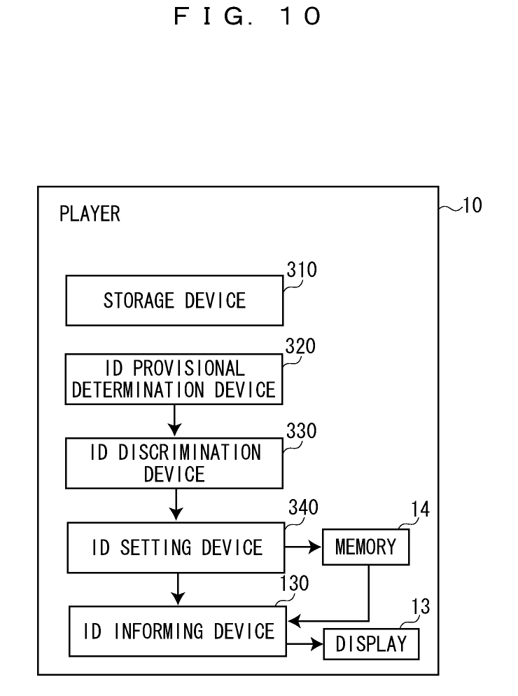

FIG. 10 is a functional block diagram of the player 10 according to the fourth embodiment. The player 10 of the fourth embodiment has a storage device 310, an ID provisional determination device 320, an ID discrimination device 330, an ID setting device 340 and an ID informing device 130 as main functional structures.

The storage device 310 stores a plurality of IDs for specifying itself. In other words, a plurality of numeric values such as “1” - “20” are stored as the IDs. The ID provisional determination device 320 provisionally determines one arbitrary ID among the plurality of IDs stored in the storage device 310 as an ID thereof. In this embodiment, the provisional determination is made in the order of number from the numeric value “1”.

The ID discrimination device 330 discriminates whether the arbitrary ID provisionally determined by the ID provisional determination device 320 has been assigned to the other player 10. If it is discriminated that the ID has been assigned to the other player 10, another ID is provisionally determined by the ID provisional determination device 320 and the discrimination is repeated.

The ID setting device 340 sets the arbitrary ID as the ID thereof (stores in the memory 14) when the arbitrary ID has not been assigned to the other player 10 based on the discrimination by the ID discrimination device 330. Further, the ID informing device 130 displays the ID on the display 13 as each embodiment above.

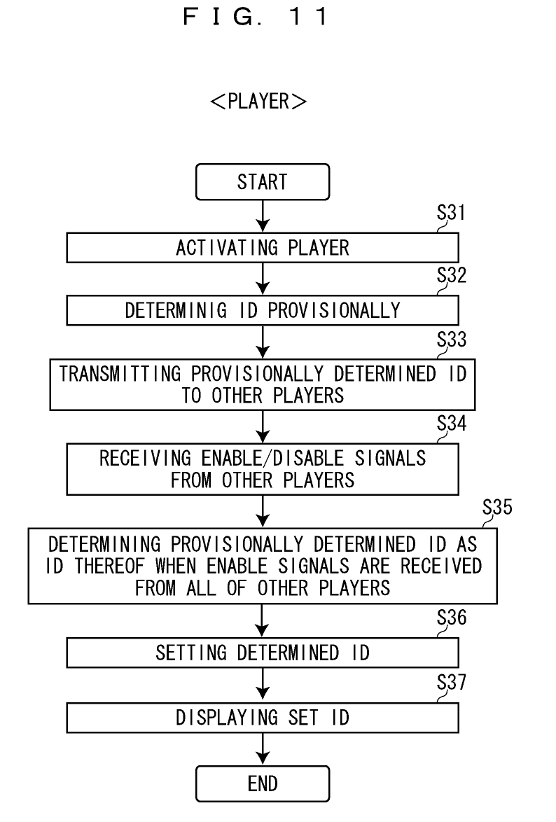

FIG. 11 is a flowchart illustrating the ID setting process of the player 10 according to the fourth embodiment. When a power button (not shown) is pressed down and the player 10 is activated (S31), it provisionally determines one ID among the plurality of IDs stored in the storage device 310 (S32). The player 10 transmits the provisionally determined ID to the other player 10 connected in LAN (S33) and receives an enable signal or a disable signal from the other player 10 (S34).

When the enable signal(s) from all the connected player(s) 10 is/are received (or when the disable signal(s) from all the player(s) 10 is/are not received), the provisionally determined ID is determined as the ID thereof (S35). Then, the provisional determined ID is set (S36) and the set ID is displayed on the display 13 (S37).

As explained above, according to the fourth embodiment of the invention, the player 10 itself can set the ID for specifying itself without the mixer. In short, it is possible to set the ID for discriminating each player 10 even when the mixer 20 does not have the ID setting function therein such as employing the existing mixer 20.

In the above embodiment, the ID setting process starts when the player 10 is activated as a trigger, but the process may start triggered by a user's predetermined operation (for example, pressing down an ID setting button).

In the case that the ID setting function is installed in the mixer 20, the ID transmitted from the mixer 20 may be overwritten in the memory 14 and displaying may be updated.

The user may select whether the ID is set by the player 10 (the fourth embodiment) or is set by the mixer (the first to the third embodiments). When the ID is set by the mixer 20, the user may select whether the ID is set based on the LAN port 21 (the first embodiment) or is set based on the audio channel 22 (the second and the third embodiments). Further, when the ID is set based on the audio channel 22, the user may select whether the audio signals are used (the second embodiment) or the specific information is used (the third embodiment).

Also, it is possible to provide each structure element of the players 10 and the mixer 20 explained in each embodiment above as a program. Further, it is possible to provide the program stored in various recording media (such as a CD-ROM, a flash memory). In other words, the program which causes a computer to function as each structure element of the player 10 and the mixer 20 and the recording medium in which the program is recorded thereon are included in the scope of the invention.

In each embodiment above, the audio signals are exemplified as the reproduction signals output from the players 10, but video signals may be used. In short, the invention can be applied to video equipment. In this regard, when the invention is applied to the video equipment and the structure such as the second or the third embodiment is used, the mixer 20 determines the IDs of the players 10 connected to video channels based on not the audio channels 22 but the video channels. Other modifications can be properly applied without departing from the scope of the invention.

[Reference Numerals]

10: player 11: LAN terminal 12: audio terminal 13: display 14: memory 15: USB memory 20: mixer 21: LAN port 22: audio channel 23: switching hub 31: LAN cable 32: audio cable SY: reproduction system

1-14. (canceled)

15. A mixer comprising:
a plurality of LAN ports that are connected with a plurality of players and input/output a control signal from/to the players;
an input detection device that detects that the control signal is input from a player after the player is connected to either one LAN port among the plurality of LAN ports;
an ID determination device that determines a port number of the detected one LAN port as an ID of a target player that is the player connected to the one LAN port; and
an ID transmission device that transmits the determined ID to the target player through the one LAN port.

16. The mixer according to claim 15 further comprising a plurality of reproduction signal input sections that receive a reproduction signal reproduced by the plurality of players, wherein the LAN port functions as the reproduction signal input section.

17. A reproduction system comprising:
a plurality of players; and
a mixer connected to the plurality of players, the mixer having:
a plurality of LAN ports that are connected with the plurality of players and input/output a control signal from/to the players;
an input detection device that detects that the control signal is input from a player after the player is connected to either one LAN port among the plurality of LAN ports;
an ID determination device that determines a port number of the detected one LAN port as an ID of a target player that is the player connected to the one LAN port; and
an ID transmission device that transmits the determined ID to the target player through the one LAN port; and, the player functioning as the target player having:
an ID reception device that receives the ID transmitted from the mixer;
an ID setting device that sets the received ID as an ID thereof; and
an ID informing device that informs the set ID.

18. The reproduction system according to claim 17, wherein the player further has, when the player is connected to one or more other players in network, a storage device that stores a plurality of IDs for specifying itself; an ID provisional determination device that provisionally determines one arbitrary ID as an ID thereof among the plurality of stored IDs; and an ID discrimination device that discriminates whether the provisionally determined arbitrary ID is assigned to an another player, and wherein the ID setting device sets the arbitrary ID as an ID thereof when no other player assigned with the arbitrary ID exists based on the discrimination result by the ID discrimination device.

19. The reproduction system according to claim 17, wherein the ID informing device informs an ID list of the other players connected to the player in addition to the set ID of the player itself.

20. A player applied to the reproduction system according to claim 17.

21. A computer-readable medium that causes a computer to function as each device of the mixer or the player in the reproduction system according to claim 17.

22. A method of controlling a mixer having a plurality of LAN ports that are connected with a plurality of players and input/output a control signal from/to the players, the method comprising steps of:
detecting that the control signal is input from a player after the player is connected to either one LAN port among the plurality of LAN ports;
determining a port number of the detected one LAN port as an ID of a target player that is the player connected to the one LAN port; and
transmitting the determined ID to the target player through the one LAN port.
